(19) United States
(12) Patent Application Publication
(10) Pub. No.: US 2010/0092934 A1
(43) Pub. Date: Apr. 15, 2010

(54) METHOD TO DETERMINE THE PSYCHOLOGICAL IMPACT OF ENTERTAINMENT OR INDIVIDUAL PRESENTERS

(76) Inventor: Richard Bernard Silberstein, Victoria (AU)

Correspondence Address: MASTERMIND IP LAW PC, 421-A SANTA MARINA COURT, ESCONDIDO, CA, 92029, US

(21) Appl. No.: 12/520,853

(22) PCT Filed: Dec. 22, 2006
(86) PCT No.: PCT/AU2006/002003

§ 371 Date: Jun. 22, 2009

(51) Int. Cl. G09B 19/00

(52) U.S. Cl. 434/236

(57) ABSTRACT

A method for determining the psychological impact of entertainment material having at least first and later episodes, the method including the steps of: (a) presenting a first episode to a target group of subjects, (b) after a predetermined period of time, presenting the later episode to the target group of subjects; (c) determining brain activities of the target group of subjects whilst the later episode is being presented to the target group of subjects; and (d) evaluating the psychological impact of the entertainment material by reference to the levels of brain activities determined in step (c). The method of presenting material and determining brain activities also being used for determining the suitability of an actor from a group of actors or selecting a person from a group of persons for a public role.

At present, the likely commercial success of newly created entertainment material such as television programs, feature films or the response to an individual presenting a message or an individual seeking public office is typically estimated by questionnaires with test audiences or focus groups drawn from test audiences that have viewed the material or the individual. Such methods are now recognized as deficient in tapping the emotional responses of the test audiences. It is such emotional responses such as the level of engagement with the material or individual, the sense of excitement, the likeability of various characters that play a crucial role in the commercial success or otherwise of the entertainment material.

An object of the present invention is to provide a more accurate method of measurement of the likely commercial success of entertainment material or response to an individual.

Generally speaking, the present invention provides a method that relies on the measurement of brain activity, rather than verbal responses to determine the psychological and especially the emotional responses to entertainment material or individuals.

According to the present invention there is provided a method for determining the psychological impact of entertainment material having at least first and later episodes, the method including the steps of:

(a) presenting a first episode to a target group of subjects;

(b) after a predetermined period of time, presenting the later episode to the target group of subjects;

(c) determining brain activities of the target group of subjects whilst the later episode is being presented to the target group of subjects; and

(d) evaluating the psychological impact of the entertainment material by reference to the levels of brain activities determined in step (c).

The invention also provides a method for determining the suitability of an actor from a group of actors for a role in entertainment material including the steps of:

(a) causing each of actors to separately perform by reading the same script or acting the same role;

(b) presenting each of the actor's performances in step (a) to a test audience;

(c) determining brain activities of the test audience separately for each of the performances; and

(d) determining the suitability of the actors for the role by reference to the brain activities determined in step (c).

The invention also provides a method of determining the selecting of a person from a group of persons for a public role, the method including the steps of:

(a) causing each person to separately make a presentation which is associated with the public role;

(b) presenting the each of the presentations of step (a) to a test audience;

(c) determining brain activities of the test audience separately for each of the persons; and

(d) selecting a person for the role by deference to the brain activities determined in step (c).

The invention also provides a system for determining the psychological impact of entertainment material having at least first and later episodes, the system including:

(a) display means for displaying a later episode of the entertainment material to a target group of subjects who have earlier viewed the first episode of the entertainment material;

(b) determining means for determining brain activities of the target group of subjects whilst the later episode is being presented to the target group of subjects; and

(c) evaluating means for evaluating the psychological impact of the entertainment material by reference to the levels of brain activity determined by said determining means.

The invention also provides a method of evaluating actors performing in entertainment material, the method including the steps of:

(a) presenting the entertainment material in which one or more actors perform to an audience;

(b) determining brain activities of the audience during presentation of the entertainment material in step (a);

(c) averaging brain activity levels separately for each of the actors when they appear in the entertainment material; and

(d) evaluating the psychological impact of each of the actors by reference to the separate brain activities determined in step (c).

Brain activity is measured while subjects view an individual addressing an audience or some entertainment material. The entertainment material could comprise an episode from an established television program or a newly created pilot program. The material could also be presented in the form of an animatic, or a story board.

In one embodiment, the procedure to evaluate an established program or a newly developed pilot episodes of a program is described as follows:
1. Individuals drawn from the target group or likely audience for the program view one or two episodes of the entertainment program.
2. On the following day, brain activity is measured while subjects view the next episode of the program.

In the situation where only animatics or story boards are available, brain activity is measured while subjects view the animatic or story board.

To determine the likely popularity of a completed program or early material, the most important measure is that of Engagement and is given by the weighted average of brain activity in 4 frontal and prefrontal sites. This is given by the following expression:

engagement=(b₁*brain activity at electrode F₃+b₂*brain activity at electrode Pₚ₁+b₃*brain activity at electrode F₄+b₄*brain activity at electrode Fₚ₂)

where b₁=0.1, b₂=0.4, b₃=0.1, b₄=0.4 Equation 1

If inverse mapping techniques are used, the relevant expression is:

engagement=(d₁*right orbito frontal cortex (in vicinity of Brodman area 11)+d₂*right dorso-lateral prefrontal cortex (in vicinity of Brodman area 9)+d₃*left orbito frontal cortex (in vicinity of Brodman area 11)+d₄*left dorso-lateral prefrontal cortex (in vicinity of Brodman area 9))

where: d₁=0.1, d₂=0.4, d₃=0.1, d₄=0.4 Equation 2

The engagement measure can also be used to estimate the likely popularity of program ideas when they are presented to a test audience in the form of animatics or story boards. Higher engagement when subjects view the animatic or story board will be associated with a higher likelihood that the finished program will be popular with the test audience.

Audience response either to an individual or to various characters in the entertainment material can also be estimated from brain activity. Greater audience acceptance of an individual or an actor is indicated by higher engagement when that actor is featured.

The likeability or the extent to which the individual or actor is liked by the audience is indicated by the Attraction-Repulsion measure.

Attraction Repulsion (sometimes termed like-dislike) is given by the difference between brain activity at left frontal/prefrontal and right frontal/prefrontal regions. Attraction is indicated by a larger brain activity in the left hemisphere compared to the right while Repulsion is indicated a larger brain activity in the right hemisphere compared to the left.

Attraction=(a₁*brain activity recorded at electrode F₃+a₂*brain activity recorded a electrode Fₚ₁−a₃*brain activity recorded at electrode F₄−a₄*brain activity recorded at electrode Fₚ₂)

where a₁=a₂=a₃=a₄=1.0 Equation 3

A positive value for the attraction measure is associated with the participants finding the character or individual attractive and liked while a negative measure is associated with repulsion or dislike.

If inverse mapping techniques are used, the relevant expression is:

Attraction=(c₁*brain activity at right orbito-brain activity at frontal cortex (in vicinity of Brodman area 11)+c₂*brain activity at right dorso-lateral prefrontal cortex (in vicinity of Brodman area 9)+c₃*brain activity at left orbito-frontal cortex (in vicinity of Brodman area 11)+c₄*brain activity at left dorso-lateral prefrontal cortex (vicinity of Brodman area 9))

where c₁=1, c₂=1, c₃=1, c₄=1 Equation 4

The memorability or extent to which an actor's role is encoded in long-term memory is dependent upon long term memory encoding for details and verbal memories associated with an actor's role. This is indicated by SSVEP phase advance or amplitude change at left frontal region, preferably approximately equidistant from left hemisphere electrodes C₃, F₃ and F₇ at the time that the actor is featured. If inverse mapping techniques are used, the relevant location in the left cerebral cortex is the vicinity of Brodmans areas 6, 44, 45, 46 and 47.

Long term memory encoding for emotional and non-verbal memories associated with an actor's role. This is indicated by SSVEP phase advance or amplitude change at left frontal region, preferably approximately equidistant from left hemisphere electrodes C₄, F₄ and F₈ at the time that the actor is featured. If inverse mapping techniques are used, the relevant location in the right cerebral cortex is the vicinity of Brodmans areas 6, 44, 45, 46 and 47.

The emotional excitement associated with a speech given by an individual or a program or a scene in a program is given by the Emotional Intensity measure.

Emotional intensity, indicated by brain activity at right parieto-temporal region, preferable approximately equidistant from right hemisphere electrodes O₂, P₄ and T₆. If inverse mapping techniques are used, the relevant location in the right cerebral cortex is the vicinity of the right parieto-temporal junction.

The brain activity measures of Engagement, Attraction-Repulsion and Emotional Intensity can also be used to select the most suitable performer or actor for a given role. In this case, an audience would view each of the applicants for a part performing a given scene in a program. The actor eliciting the highest level of Engagement and Likeability (on the Attract-Repulsion score) would be the most suitable one for the role. In the case of an individual giving an election speech or a presentation, the measures of Engagement, Attraction-Repulsion and Emotional Intensity associated with different points made in the speech would enable identification of the issues that elicit the strongest responses in the audience. The issues that elicit the strongest responses are thus those that have the greatest impact on the wider audience.

This method of evaluating entertainment material can also be used with different media such as entertainment delivered to a computer over the internet or entertainment delivered to a mobile phone or other digital media.

### Measuring Brain Activity

A number of methods are available for measuring brain activity. The main feature they must possess is adequate temporal resolution or the capacity to track the rapid changes in brain activity. Spontaneous brain electrical activity or the electroencephalogram (EEG) or the brain electrical activity evoked by a continuous visual flicker that is the Steady State Visually Evoked (SSVEP) are two examples of brain electrical activity that can be used to measure changes in brain activity with sufficient temporal resolution. The equivalent spontaneous magnetic brain activity or the magnetoencephalogram (MEG) and the brain magnetic activity evoked by a continuous visual flicker Steady State Visually Evoked Response (SSVER).

### Electroencephalogram and Magnetoencephalogram (EEG and MEG)

The EEG and MEG are the record of spontaneous brain electrical and magnetic activity recorded at or near the scalp surface. Brain activity can be assessed from the following EEG or MEG components.

### 1. Gamma or High Frequency EEG or MEG Activity

This is generally defined as EEG or MEG activity comprising frequencies between 35 Hz and 80 Hz. Increased levels of Gamma activity are associated with increased levels of brain activity, especially concerned with perception. (Fitzgibbon S P, Pope K J, Mackenzie L, Clark C R, Willoughby J O. Cognitive tasks augment gamma EEG power. Clin Neurophysiol. 2004: 115:1802-1809).

If scalp EEG gamma activity is used as the indicator of brain activity, the relevant scalp recording sites are listed above. If EEG gamma activity at the specific brain regions listed above is used as the indicator brain activity then inverse mapping techniques such as LORETA must be used (Pascual-Marqui R, Michel C, Lehmann D (1994): Low resolution electromagnetic tomography: a new method for localizing electrical activity in the brain. Int J Psychophysiol 18:49-65).

If MEG gamma activity at the specific brain regions listed above is used as the indicator of brain activity, then the multi-detector MEG recording system must be used in conjunction with an MEG inverse mapping technique (see Uutela K, Ha\ddot{}ma\ddot{b}\ddot{}la\ddot{}inen M, Somersalo E (1999): Visualization of magnetoencephalographic data using minimum current estimates. Neuroimage 10:173-180 and Fuchs M, Wagner M, Kohler T, Wischmann H A (1999): Linear and nonlinear current density reconstructions, J Clin Neurophysiol 16:267-295).

### 2. Frequency of EEG or MEG Alpha Activity

Brain activity may also be indexed by changes in the frequency of the ongoing EEG or MEG in the alpha frequency range (8.0 Hz-13.0 Hz). Increased frequency is an indication of increased activity. The frequency needs to me estimated with high temporal resolution. Two techniques that can be used to measure ‘instantaneous frequency’ are complex demodulation (Walter D, The Method of Complex Demodulation. Electroencephalog. Clin. Neurophysiol, 1968 Suppl 27:53-7) and the use of the Hilbert Transform (Leon Cohen, “Time frequency analysis”, Prentice-Hall, 1995). Increased brain activity is indicated by an increase in the instantaneous frequency of the EEG in the alpha frequency range.

If the frequency of scalp EEG alpha activity is used as the indicator of brain activity, the relevant scalp recording sites are listed above. If the frequency of EEG alpha activity at the specific brain regions listed above is used as the indicator brain activity then inverse mapping techniques such as LORETA must be used (Pascual-Marqui R, Michel C, Lehmann D (1994): Low resolution electromagnetic tomography: a new method for localizing electrical activity in the brain. Int J Psychophysiol 18:49-65).

If the frequency of MEG alpha activity at the specific brain regions listed above is used as the indicator of brain activity, then the multi-detector MEG recording system must be used in conjunction with an MEG inverse mapping technique (see Uutela K, Ha\ddot{}ma\ddot{}la\ddot{}inen M, Somersalo E (1999): Visualization of magnetoencephalographic data using minimum current estimates. Neuroimage 10:173-180, and Fuchs M, Wagner M, Kohler T, Wischmann H A (1999): Linear and nonlinear current density reconstructions, J Clin Neurophysiol 16:267-295).
3. SSVEP or SSVER Phase as an Indicator of Brain Activity

Brain activity may also be indicated by the phase of the Steady State Visually Evoked Potential (SSVEP) or the Steady State Visually Evoked Response (SSVER).

U.S. Pat. Nos. 4,955,938; 5,331,969; and 6,792,304 (the contents of which are hereby incorporated herein by reference) disclose technique for obtaining a steady state visually evoked potential (SSVEP) from a subject. This technique can also be used to obtain a steady state visually evoked response (SSVER). These patents disclose the use of Fourier analysis in order to rapidly obtain the SSVEP and SSVER phase and changes thereto. The preferred way in which SSVEP and SSVER amplitudes and phases are calculated are summarised below.

### SSVEP and SSVER Amplitude and Phase

The digitized brain electrical activity (electroencephalogram or EEG) brain magnetic activity (MEG) together with timing of the stimulus zero crossings enables one to calculate the SSVEP or SSVER elicited by the flicker at a particular stimulus frequency from the recorded EEG or MEG or from EEG or MEG data that has been pre-processed using Independent Components Analysis (ICA) to remove artefacts and increase the signal to noise ratio. [Bell A. J. and Sejnowski T. J. 1995, An information maximisation approach to blind separation and blind deconvolution, Neural Computation, 7, 6, 1129-1159; T-P. Jung, S. Makeig, M Westerfield, J. Townsend, E. Courchesne and T. J. Sejnowskik, Independent component analysis of single-trial event-related potential Human Brain Mapping, 14(3):168-85,2001].

Calculation of SSVEP or SSVER amplitude and phase for each stimulus cycle for a given stimulus frequency. Calculation accomplished used Fourier techniques using Equations 5 and 6 below.

$${a}_{n} = \frac{1}{S Δ τ} {\sum }_{i = 0}^{S - 1} f ( nT + i Δ τ ) cos ( \frac{2 π}{T} ( nT + i Δ τ ) ) \\ {b}_{n} = \frac{1}{S Δ τ} {\sum }_{i = 0}^{S - 1} f ( nT + i Δ τ ) sin ( \frac{2 π}{T} ( nT + i Δ τ ) ) \qquad Equation 5$$

Calculation of SSVEP Fourier components where aₙ and bₙ are the cosine and sine Fourier coefficients respectively. n represents the nth stimulus cycle, S is the number of samples per stimulus cycle (16), Δτ is the time interval between samples, T is the period of one cycle and f(nT+iΔτ) is the EEG or MEG signal (raw or pre-processed using ICA).

$${SSVEP}_{amplitude} = \sqrt{( {A}_{n}^{2} + {B}_{n}^{2} )} \\ or \\ {SSVER}_{amplitude} = \sqrt{( {A}_{n}^{2} + {B}_{n}^{2} )} \\ {SSVEP}_{phase} = a tan ( \frac{{B}_{n}}{{A}_{n}} ) \\ or \\ {SSVER}_{phase} = a tan ( \frac{{B}_{n}}{{A}_{n}} ) \qquad Equation 6$$

Where Aₙ and Bₙ are overlapping smoothed Fourier coefficients calculated by using Equation 7 below.

$${A}_{n} = {\sum }_{i = 1}^{i = N} {a}_{n + i} / N \\ {B}_{n} = {\sum }_{i = 1}^{i = N} {b}_{n + i} / N \qquad Equation 7$$

Amplitude and phase components can be calculated using either single cycle Fourier coefficients (aₙ and bₙ) or coefficients that have been calculated by smoothing across multiple cycles (Aₙ and Bₙ).

Equations 6 and 7 describe the procedure for calculating the smoothed SSVEP or SSVER coefficients for a single subject. For pooled data, the SSVEP or SSVER coefficients (Aₙ and Bₙ) for a given electrode are averaged (or pooled) across all of the subjects or a selected group of subjects.

As the number of cycles used in the smoothing increases, the signal to noise ratio increases while the temporal resolution decreases. The number of cycles used in the smoothing is typically in excess of 5 and less than 130.

Equations 6 and 7 apply to scalp SSVEP data as well as brain electrical activity inferred at the cortical surface adjacent to the skull and deeper regions. Activity in deeper regions of the brain such as the orbito-frontal cortex or ventro-medial cortex can be determined using a number of available inverse mapping techniques such as EMSE (Source Signal Imaging, Inc, 2323 Broadway, Suite 102, San Diego, Calif. 92102, USA) and LORETA (Pascual-Marqui R, Michel C, Lehmann D (1994): Low resolution electromagnetic tomography: a new method for localizing electrical activity in the brain. Int J Psychophysiol 18:49-65). If the SSVER amplitude or phase changes at the specific brain regions listed above are used as the indicator of brain activity, then the multi-detector MEG recording system must be used in conjunction with an MEG inverse mapping technique (see Uutela K, Ha\ddot{}ma\ddot{}la\ddot{}inen M, Somersalo E (1999): Visualization of magnetoencephalographic data using minimum current estimates, Neuroimage 10:173-180, and Fuchs M, Wagner M, Kohler T, Wischmann H A (1999): Linear and nonlinear current density reconstructions, J Clin Neurophysiol 16:267-295).

The invention will now be further described with reference to the accompanying drawings, in which:

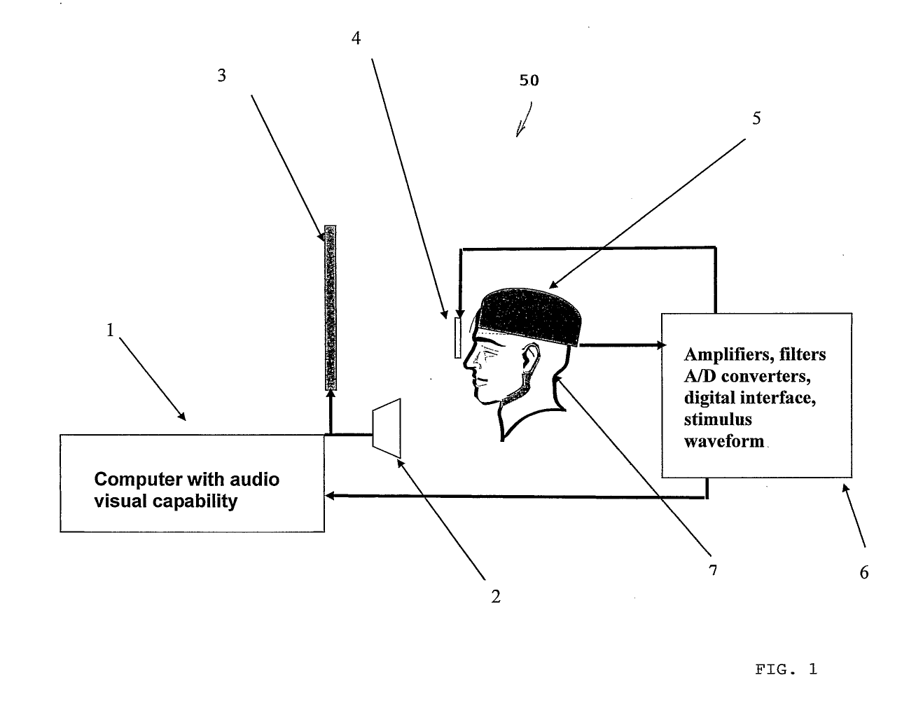

FIG. 1 is a schematic view of a system of the invention;

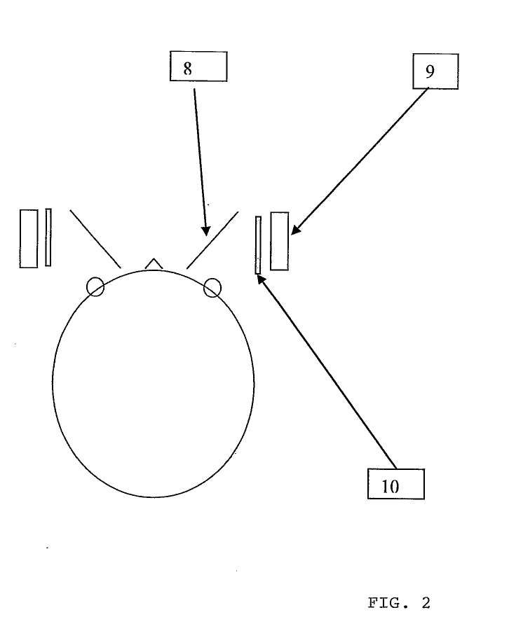

FIG. 2 is a schematic view showing in more detail the manner in which visual flicker stimuli are presented to a subject;

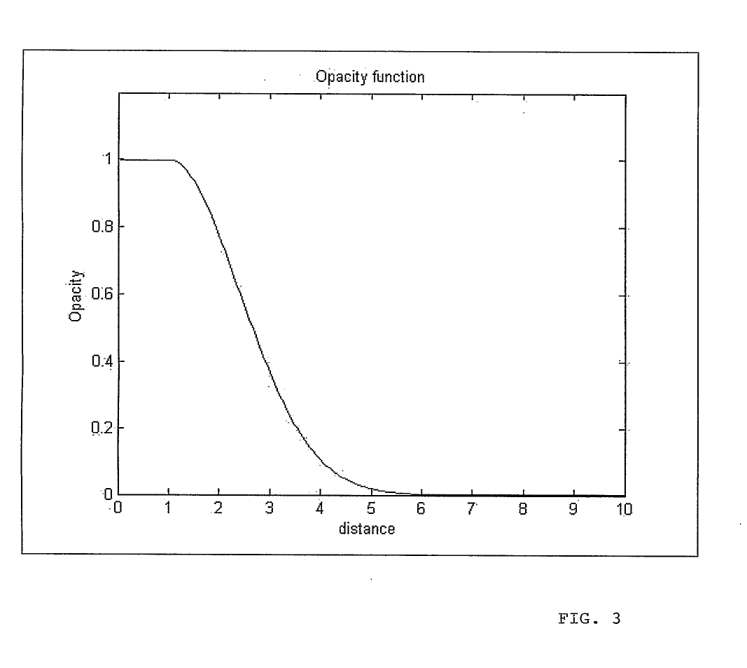

FIG. 3 is a graph showing the opacity of the screen as a function of radius;

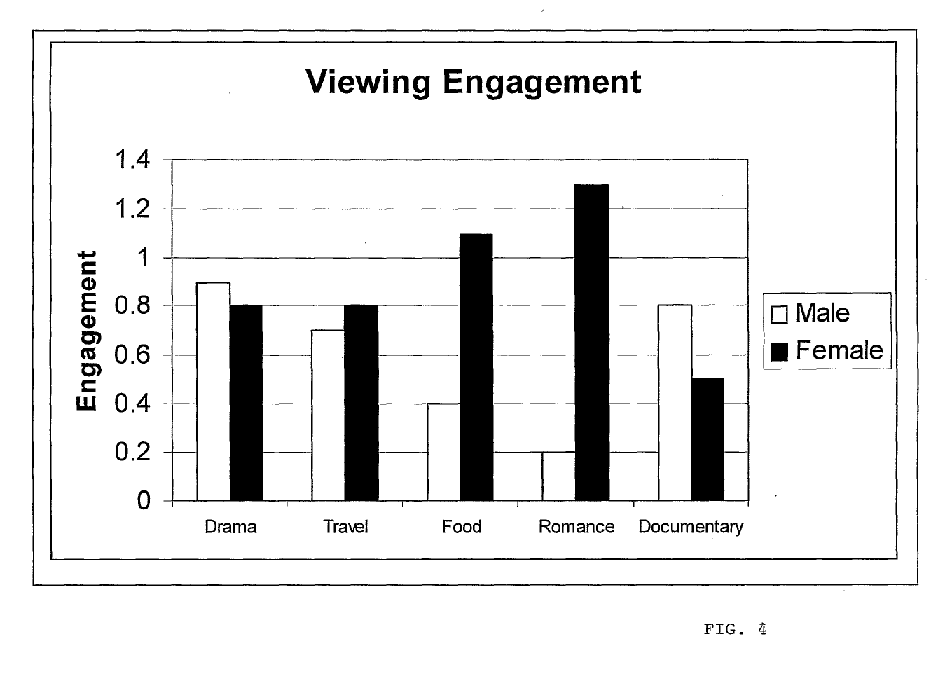

FIG. 4 graphically shows the measures for viewing engagement for male and female subjects for different types of entertainment material;

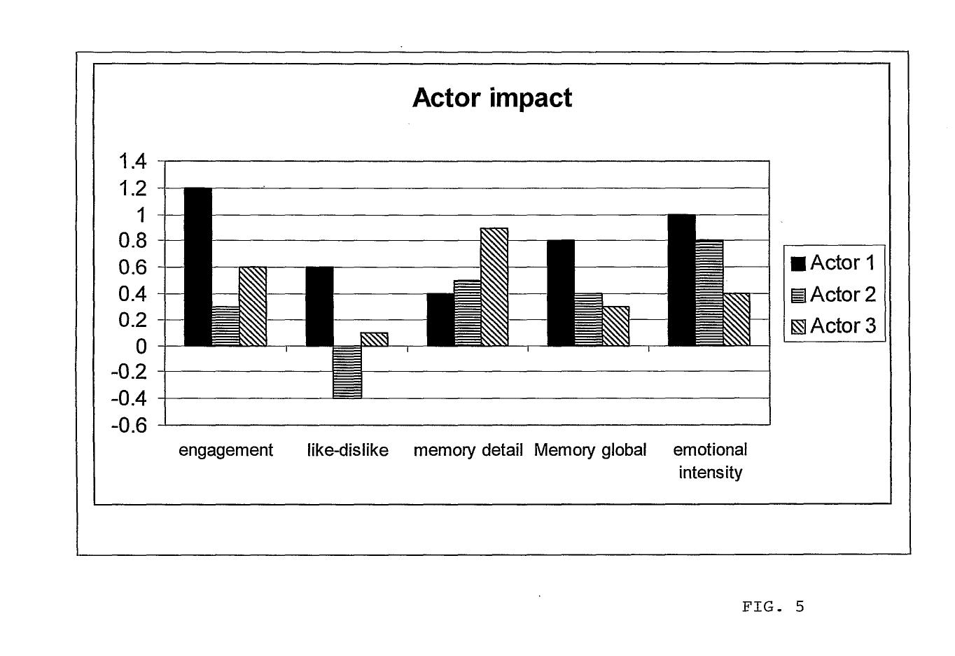

FIG. 5 graphically shows different measures of impact for three different actors; and

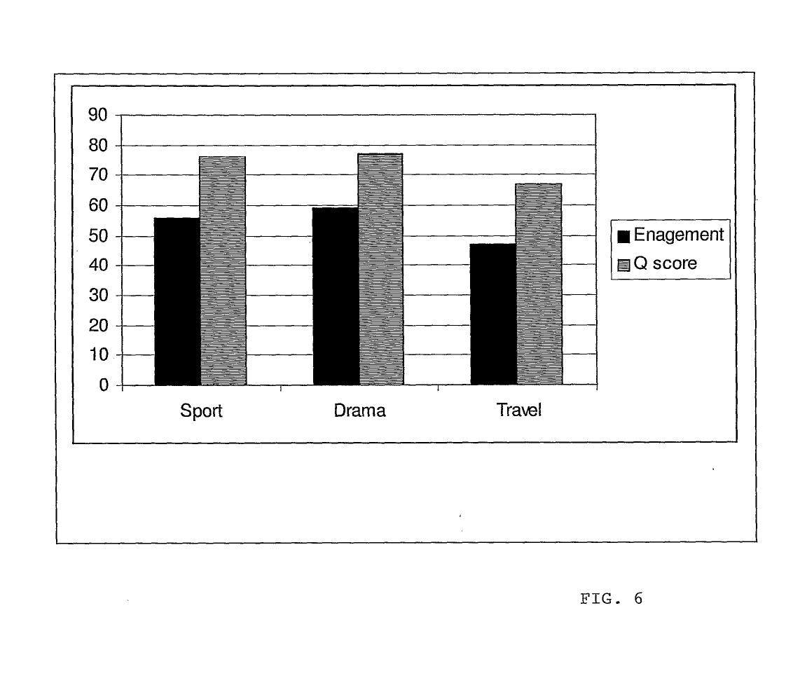

FIG. 6 shows correlation between the techniques of the invention and known assessment techniques.

FIG. 1 schematically illustrates a system 50 for determining the response of a subject or a group of subjects to audio-visual material presented on a video screen 3 and loudspeaker 2. The system includes a computer 1 which controls various parts of the hardware and also performs computation on signals derived from the brain activity of the subject 7, as will be described below. The computer 1 also holds the images and sounds which can be presented to one or more subjects 7 on the screen 3 and/or through the loudspeaker 2.

The subject or subjects 7 to be tested are fitted with a headset 5 which includes a plurality of electrodes for obtaining brain electrical activity from various sights on the scalp of the subject 7. In the event that the SSVER is used, the recording electrodes in the headset 5 are not used and a commercial MEG recording system such as the CTF MEG System manufactured by VSM MedTech Ltd. of 9 Burbidge Street, Coquitlam, BC, Canada, can be used instead. The headset includes a visor 4 which includes half silvered mirrors 8 and white light Light Emitting Diode (LED) arrays 9, as shown in FIG. 2. The half silvered mirrors are arranged to direct light from the LED arrays 9 towards the eyes of the subject 7. The LED arrays 9 are controlled so that the light intensity there from varies sinusoidally under the control of control circuitry 6. The control circuitry 6 includes a waveform generator for generating the sinusoidal signal. In the event that the SSVER is used, the light from the LED array is conveyed to the visor via a fibre optic system. The circuitry 6 also includes amplifiers, filters, analogue to digital converters and a USB interface or a TCP interface or other digital interface for coupling the various electrode signals into the computer 1.

A translucent screen 10 is located in front of each LED array 9. Printed on the screen is an opaque pattern. The opacity is a maximum in a circular area in the centre of the centre of the screen. Beyond the circular area, the opacity falls off smoothly with radial distance from the circular area circumference, preferably, the opacity should fall off as a Gaussian function described by Equation 8. The screen reduces the flicker in the central visual field thus giving subjects a clear view of the visually presented material. The size of the central opaque circle should be such as to occlude the visual flicker in the central visual field between 1-4 degrees vertically and horizontally.

If r<R then P=1

If then P is given by Equation 8 below.

P=e^{-(r-R)}^{²}^{/G}^{²} Equation 8

where P is the opacity of the pattern on the translucent screen. An opacity of P=1.0 corresponds to no light being transmitted through the screen while an opacity of P=0 corresponds to complete transparency.

R is the radius of the central opaque disk while r is the radial distance from the centre of the opaque disk. G is a parameter that determines the rate of fall-off of opacity with radial distance. Typically G has values between R/4 and 2R. FIG. 3 illustrates the fall-off of opacity with radial distance from the centre of the disk. In FIG. 3, R=1 and G=2R.

The computer 1 includes software which calculates SSVEP or SSVER amplitude and phase from each of the electrodes in the headset 5 or MEG sensors.

Details of the hardware and software required for generating SSVEP and SSVER are well known and need not be described in detail. In this respect reference is made to the aforementioned United States patent specifications which disclose details of the hardware and techniques for computation of SSVEP. Briefly, the subject 7 views the video screen 3 through the visor 4 which delivers a continuous background flicker to the peripheral vision. The frequency of the background flicker is typically 13 Hz but may be selected to be between 3 Hz and 50 Hz. More than one flicker frequency can be presented simultaneously. The number of frequencies can vary between 1 and 5. Brain electrical activity will be recorded using specialized electronic hardware that filters and amplifies the signal, digitizes it in the circuitry 6 where it is then transferred to the computer 1 for storage and analysis.

When using the SSVEP, brain electrical activity is recorded using multiple electrodes in headset 5 or another commercially available multi-electrode system such as Electro-cap (ECI Inc., Eaton, Ohio USA). When using the SSVER, commercial MEG recording system such as the CTF MEG System manufactured by VSM MedTech Ltd may be used. The number of electrodes or magnetic recording sites is normally not less than 8 and normally not more than 128, typically 16 to 32.

Brain electrical activity at each of the electrodes is conducted to a signal conditioning system and control circuitry 6. The circuitry 6 includes multistage fixed gain amplification, band pass filtering and sample-and-hold circuitry for each channel. Amplified/filtered brain activity is digitized to 16-24 bit accuracy at a rate not less than 300 Hz and transferred to the computer 1 for storage on hard disk. The timing of each brain electrical sample together with the time of presentation of different components of the audio-visual material are also registered and stored to an accuracy of 10 microseconds. The equivalent MEG recording system that is commercially available performs the same functions.

SSVEP and SSVER amplitude and phase can be calculated in accordance with the above.

While one or more subjects are viewing the images to be evaluated, the visual flicker is switched on in the visor 4 and brain electrical activity is recorded continuously on the computer 1.

At the end of the recording stage, the SSVEP or SSVER amplitude and phase are separately calculated for each individual. Once all recordings are completed, group averaged data is calculated by averaging the smoothed SSVEP opr SSVER amplitude and phase data from subjects to be included in the group (eg male, female, young, old).

### EXAMPLE 1

The following procedure is used to evaluate the likely success of new entertainment material or the release of established entertainment material to a new target audience.

In this example, 50 to 200 participants drawn from the likely target audience for the test entertainment material are recruited into the study. All participants view at least one episode or part of the entertainment material at either one or more locations or in the home. In this Example, viewer engagement is important and accordingly the electrodes in the headsets 5 are selected so as to enable engagement to be calculated using the techniques described earlier. Brain activity is also preferably determined using SSVEP. The engagement measures of the target audiences were separated into males and females and the results were plotted graphically in FIG. 4. FIG. 4 shows the engagement measures for the male and female audiences for five different types of programs, drama, travel, food, romance and documentary. Later, ideally no less than 24 hours later, brain activity is recorded while the participants view a subsequent episode or part of the entertainment material as described in more detail below.

To record brain activity, a selected number of subjects, say 50, are seated in a test room and the headsets 5 are placed on their heads. The visors 4 are then placed in position and adjusted so that the foveal block by the screens 10 prevents the appearance of the flicker over the screens 3 where the images are presented. The number of subjects in a recording session is variable and typically can vary from 1 to over 100. When pooling subjects to create the average response, the number of subjects whose data is to be included in the average should preferably be no less than 16.

To minimize irritation or discomfort to the participants due to the flicker, the flicker stimulus is of variable intensity and only switched to the highest intensity when material of interest to the client such as particular segments of the program or specific actors appear on the screen. During the periods that material of interest is not present on the screen, the stimulus intensity is typically zero and never more than 10% of the typical value used when material of interest is on the screen. Preferably, the stimulus is not switched on abruptly but is slowly increased before the segment of interest is displayed and decreased slowly after the end of the material of interest. Typically, the stimulus is increased linearly over a 30-60 second epoch prior to the appearance of the material of interest so that it reaches its maximum value 60 seconds prior to the appearance of the material of interest. At the end of every segment of interest, a 30 second sequence of still images of scenery and a musical accompaniment is presented. Typically, 60 images are presented over the period of 30 seconds with each image present for about 0.5 seconds. Brain activity levels during the adjacent scene images are used as a reference level for brain activity during the preceding segment of interest. This enables removal of any long-term changes in brain activity that may occur over the time course of the recording period.

Immediately the sequence of reference images at the end of the segment of interest ends, the stimulus intensity is linearly reduced to the minimum value over a 30 second period. The slow linear increase and decrease of stimulus intensity occurs for every segment of interest.

The likely audience engagement is given by the brain engagement measure time averaged over at least 5 minutes of a typical segment of the new entertainment material ‘ engagement being calculated separately for males and females using the SSVEP techniques described above. As can be seen, for males, the programs with the highest engagement, and hence the greatest likelihood of success are the drama and documentary programs while for the females audience: the romance and food programs are most likely to be successful.

### EXAMPLE 2

The invention can also be used to determine the psychological impact of various actors which are featured in entertainment material. This example is similar to Example 1 except that it is not necessary that the target audience has viewed an earlier episode of the entertainment material. Also the electrodes are selected so as to enable assessment of engagement, like-dislike, memory for detail and verbal features, memory for non-verbal features and emotion, emotional intensity. Again, brain activities are preferably measured using SSVEP techniques. In this example, a segment of entertainment material has three different actors, Actor 1, Actor 2 and Actor 3 featuring therein. Pooled responses are plotted graphically in FIG. 5 for the various hypothetical measures. It is apparent from FIG. 5 that Actor 1 scores high on engagement, likeability and emotional intensity. This indicates that the audience is able to identify with the Actor 1 (indicated by high engagement), likes the actor (high likeability) and finds the actor exciting (high emotional intensity). By contrast, Actor 2 is disliked and also arouses strong emotion. This actor could be a good choice to play the part of a villain. Finally, Actor 3 is modestly engaging and the details of his role are well remembered (high memory for detail). Actor 3 could be well suited to educational roles where content is more important.

### EXAMPLE 3

The invention can also be used to select an actor for a specific role. In this application, each of the possible actors is required to read the same script or act the same role. Brain activity is then recorded from the test audience while viewing each of the applicants for the given role. Depending on the nature of the role (e.g. hero, villain etc.) the actor most effectively eliciting the desired psychological response would be selected for the part. Most relevant measures for the central characters would be engagement, like-dislike, emotional intensity. If the role also has an educational or information transfer component, long-term memory encoding would also be important.

It will be appreciated by those skilled in the art that the method of the invention compares very favourably with known techniques for evaluating the likely commercial success of entertainment material, suitability of actors or suitability of persons for public office. In the case of entertainment material, known analytical techniques can be used to determine a behavioural measure such as a Q-Score. The Q-Score indicates the desire the average viewer feels about watching a particular program. Typically, the Q-Score is only available for programs where a number of complete episodes have been viewed by the target audience. In the case of new entertainment material, this would be quite time consuming and expensive to produce. By contrast, the assessment techniques based on engagement measures give an indication of the popularity based on the pilot program which of course is relatively inexpensive to produce. FIG. 6 illustrates the average level of engagement multiplied by 100 estimated from an audience of 150 subjects over a five minute period when watching three television programs, sport, drama and travel. The level of engagement measured from brain activity in accordance with the invention is shown in solid black bars. Corresponding data obtained from known Q-Score techniques are plotted in striped bars. It will be seen that there is a strong correlation between the techniques of the invention and the Q-Score results, notwithstanding that the techniques of the invention have been based on a pilot programs.

Many modifications will be apparent to those skilled in the art without departing from the spirit and scope of the invention.

1. A method for determining the psychological impact of entertainment material having at least first and later episodes, the method including the steps of:
(a) presenting a first episode to a target group of subjects;
(b) after a predetermined period of time, presenting the later episode to the target group of subjects;
(c) determining brain activities of the target group of subjects whilst the later episode is being presented to the target group of subjects; and
(d) evaluating the psychological impact of the entertainment material by reference to the levels of brain activities determined in step (c).

2. A method as claimed in claim 1 wherein step (e) includes the step of averaging the brain activities determined in step (c).

3. A method as claimed in claim 1 wherein step (a) includes presenting first and second episodes to the target group of subjects.

4. A method as claimed in claim 1 wherein the episodes of the entertainment material are in the form of animatics or story boards.

5. A method as claimed in claim 1 wherein:
step (c) includes presenting the later episode or episodes as segments in an audiovisual presentation;
after each segment, presenting reference material to the target group of subjects;
determining reference levels of brain activities whilst the reference material is presented to the target group of subjects; and
removing the effect of long-term changes in brain activities by subtracting the reference levels of brain activities from the levels of brain activity determined in step (c).

6. A method as claimed in claim 5 wherein the reference material includes a sequence of still images.

7. A method as claimed in claim 1 wherein step (b) is carried out by displaying the later episode on a video screen.

8. A method as claimed in claim 1 wherein step (c) is carried out by determining gamma or high frequency EEG or MEG activity.

9. A method as claimed in claim 1 wherein step (c) is carried out by detecting EEG or MEG activity in the frequency range 8 to 13 Hz.

10. A method as claimed in claim 1 wherein step (c) is carried out by assessment of the phase of steady state visually evoked potentials (SSVEP) in EEG signals obtained from the target group of subjects or by assessment of steady state visually evoked responses (SSVER) in MEG signals obtained from the target group of subjects.

11. A method as claimed in claim 1 wherein step (c) includes the steps of placing electrodes at scalp sites to obtain output EEG signals which enable assessment of:
engagement with the entertainment material;
attraction-repulsion of the entertainment material;
long term memory encoding associated with the entertainment material; and/or
emotional intensity associated with the entertainment material.

12. A method as claimed in claim 11 including the step of applying a sinusoidally varying visual flicker stimulus to each subject during step (c) to thereby enable calculation of Fourier coefficients from said output signals to thereby enable calculation of said SSVEP amplitudes and/or phase differences.

13. A method as claimed in claim 12 wherein said SSVEP amplitude and phase are calculated by the equations:
$${SSVEP}_{amplitude} = \sqrt{( {A}_{n}^{2} + {B}_{n}^{2} )}$$
$${SSVEP}_{phase} = a tan ( \frac{{B}_{n}}{{A}_{n}} )$$
where: aₙ and bₙ are cosine and sine Fourier coefficients calculated by the equations:
$${a}_{n} = \frac{1}{S Δ τ} {\sum }_{i = 0}^{S - 1} f ( nT + i Δ τ ) cos ( \frac{2 π}{T} ( nT + i Δ τ ) )$$
$${b}_{n} = \frac{1}{S Δ τ} {\sum }_{i = 0}^{S - 1} f ( nT + i Δ τ ) sin ( \frac{2 π}{T} ( nT + i Δ τ ) )$$
where:
aₙ and bₙ are the cosine and sine Fourier coefficients respectively where;
n represents the nth flicker stimulus cycle;
S is the number of samples per flicker stimulus cycle;
Δτ is the time interval between samples;
T is the period of one cycle;
f(nT+iΔτ) is the EEG signal (raw or pre-processed using ICA) obtained from said predetermined scalp sites;
and wherein Aₙ and Bₙ are overlapping smoothed Fourier coefficients calculated by using the equation:
$${A}_{n} = {\sum }_{i = 1}^{i = N} {a}_{n + i} / N$$
$${B}_{n} = {\sum }_{i = 1}^{i = N} {b}_{n + i} / N$$

14. A method as claimed in claim 13 including the steps of:
obtaining EEG signals from a plurality of scalp sites of each subject; and
utilising inverse mapping techniques such as BESA, EMSA or LORETA to produce modified EEG signals which represent activity in deeper regions of the brain of each subject such as the orbito-frontal cortex or the ventro-medial cortex.

15. A method as claimed in claim 13 including the step of averaging the Fourier coefficients Aₙ and Bₙ for a selected group of the target subjects and then calculating the SSVEP amplitudes and SSVEP phase differences for said group of subjects.

16. A method as claimed in claim 12 wherein the flicker signal is applied only to the peripheral vision of each subject.

17. A method as claimed in claim 16 including the steps of directing the flicker signal towards the eyes of each subject via first and second screens and wherein each screen includes an opaque area, and wherein the method further includes the step of positioning the screens to the relative position of each subject such that said opaque areas prevent said flicker signal impinging on the fovea of each eye of each subject.

18. A method as claimed in claim 17 wherein the opacity of each screen decreases as a function of distance from its opaque area so that the intensity of the flicker signal impinging on each retina of each subject decreases in value from the central vision to the peripheral vision.

19. A method as claimed in claim 18 including the step of applying a masking pattern to each screen to define the opacity thereof, the method including the step of applying the pattern in accordance with a masking pattern function which provides zero or low gradients for changes in opacity adjacent to its opaque area and peripheral areas thereof which define parts of the flicker signal impinging on the peripheral vision of each subject.

20. A method as claimed in claim 19 wherein the opaque area of each screen is circular and wherein the masking pattern function is selected to be a Gaussian function, so that the opacity P of the screen is defined by the equation:
P=e^{-(r-R}^{²}^{/G}^{²}
where:
r is the radial distance from the centre of the opaque area; and
G is a parameter that determines the rate of fall-off of opacity with radial distance, and wherein when r<R, P=1.

21. A method as claimed in claim 20 wherein G has a value in the range R/4 and 2R.

22. A method as claimed in claim 13 including the step of applying an electrode to the scalp of each subject at a site which is approximately equidistant from sites O₂, P₄ and T₆, calculating SSVEP amplitudes and phase differences from EEG signals from said electrode whereby the output signals indicate each subject's emotional intensity associated with the entertainment material or selected actors.

23. A method as claimed in claim 14 wherein the step of utilising inverse mapping determines brain activity in the right cerebral cortex in the vicinity of the right parieto-temporal junction whereby the output signals indicate each subject's emotional intensity associated with the entertainment material or selected actors.

24. A method as claimed in claim 13 including the steps of applying an electrode to the scalp of each subject at the F₃, F₄, Fₚ₁ and Fₚ₂ sites, calculating SSVEP amplitudes and phase differences from EEG signals from said electrodes, calculating values for attraction-repulsion using the equation:
attraction=(a₁*SSVEP phase advance at electrode F₃+a₂*SSVEP phase advance at electrode Fₚ₁−a₃*SSVEP phase advance at electrode F₄−a₄*SSVEP phase advance at electrode Fₚ₂)
where a₁=a₂=a₃=a₄=1.0
whereby said values indicate each subject's like-dislike towards the entertainment material or selected actors.

25. A method as claimed in claim 14 wherein the step of utilising inverse mapping determines brain activity in:
the right orbito-frontal cortex in the vicinity of Brodman area 11;
the right dorso-lateral prefrontal cortex in the vicinity of Brodman area 9;
the left orbito frontal cortex in the vicinity of Brodman area 11; and
the left dorso-lateral prefrontal cortex in the vicinity of Brodman area 9; and
calculating a value for attraction-repulsion using the equation:
attraction=(c₁*right orbito-frontal cortex (in vicinity of Brodman area 11)+c₂*right dorso-lateral prefrontal cortex (in vicinity of Brodman area 9)+c₃*left orbito frontal cortex (in vicinity of Brodman area 11)+c₄*left dorso-lateral prefrontal cortex (vicinity of Brodman area 9))
where c₁=1, c₂=1, c₃=1, c₄=1,
whereby said values indicate each subject's like-dislike towards the entertainment material or selected actors.

26. A method as claimed in claim 13 including the steps of applying electrodes to the scalp of each subject at F₃, F₄, Pₚ₁ and Fₚ₂ sites, calculating SSVEP amplitudes and phase differences from said electrodes, calculating values for engagement in features of the advertisement by a weighted mean SSVEP phase advance at said sites using the equation:
engagement=(b₁*SSVEP phase advance at electrode F₃+b₂*SSVEP phase advance at electrode Pₚ₁+b₃*SSVEP phase advance at electrode F₄+b₄*SSVEP phase advance at Electrode Fₚ₂)
where b₁=0.1, b₂=0.4, b₃=0.1, b₄=0.4,
whereby said values indicate each subject's engagement in the entertainment material or selected actors.

27. A method as claimed in claim 14 wherein the step of utilising inverse mapping determines brain activity in:
the right orbito frontal cortex in the vicinity of Brodman area 11;
the right dorso-lateral prefrontal cortex in the vicinity of Brodman area 9;
the left frontal cortex in the vicinity of Brodman area 11; and
the left dorso-lateral prefrontal cortex in the vicinity of Brodman area 9,
calculating SSVEP amplitudes and phase differences from said modified EEG signals from said electrodes; and
calculating a value for engagement using the equation:
engagement=(d₁*right orbito frontal cortex (in vicinity of Brodman area 11)+d₂*right dorso-lateral prefrontal cortex (in vicinity of Brodman area 9)+d₃*left orbito frontal cortex (in vicinity of Brodman area 11)+d₄*left dorso-lateral prefrontal cortex (in vicinity of Brodman area 9))
where d₁=0.1, d₂=0.4, d₃=0.1, d₄=0.4,
whereby said values indicate each subject's engagement in the entertainment material or selected actors.

28. A method for determining the suitability of an actor from a group of actors for a role in entertainment material including the steps of:
(a) causing each of actors to separately perform by reading the same script or acting the same role;
(b) presenting each of the actor's performances in step (a) to a test audience;
(c) determining brain activities of the test audience separately for each of the performances; and
(d) determining the suitability of the actors for the role by reference to the brain activities determined in step (c).

29. A method of determining the selecting of a person from a group of persons for a public role, the method including the steps of:
(a) causing each person to separately make a presentation which is associated with the public role;
(b) presenting the each of the presentations of step (a) to a test audience;
(c) determining brain activities of the test audience separately for each of the persons; and
(d) selecting a person for the role by deference to the brain activities determined in step (c).

30. A method as claimed in claim 29 wherein step (c) includes the steps of placing electrodes at scalp sites of the test audience to obtain EEG signals which enable assessment of:
engagement;
attraction-repulsion (like-dislike); and/or
emotional intensity.

31. A method of evaluating actors performing in entertainment material, the method including the steps of:
(a) presenting the entertainment material in which one or more actors perform to an audience;
(b) determining brain activities of the audience during presentation of the entertainment material in step (a);
(c) averaging brain activity levels separately for each of the actors when they appear in the entertainment material; and
(d) evaluating the psychological impact of each of the actors by reference to the separate brain activities determined in step (c).

32. A method as claimed in claim 31 wherein step (b) includes the steps of placing electrodes at scalp sites to obtain EEG signals which enable assessment of:
engagement;
attraction-repulsion (like-dislike);
memory for detail and verbal features;
memory for non-verbal features and emotion; and/or emotional intensity.

33. A system for determining the psychological impact of entertainment material having at least first and later episodes, the system including:
(a) display means for displaying a later episode of the entertainment material to a target group of subjects who have earlier viewed the first episode of the entertainment material;
(b) determining means for determining brain activities of the target group of subjects whilst the later episode is being presented to the target group of subjects; and
(c) evaluating means for evaluating the psychological impact of the entertainment material by reference to the levels of brain activity determined by said determining means.
